(19) United States
(12) Patent Application Publication
(10) Pub. No.: US 2024/0375920 A1
(43) Pub. Date: Nov. 14, 2024

(54) POWER ASSIST SYSTEM FOR WINCHES

(71) Applicant: PROXDRIVE AS, Fornebu (NO)

(72) Inventors: Petter Muren, Fornebu (NO); Martin Rishovd, Oslo (NO)

(73) Assignee: PROXDRIVE AS, Fornebu (NO)

(21) Appl. No.: 18/687,574

(22) PCT Filed: Sep. 12, 2022
(86) PCT No.: PCT/EP2022/075264

§ 371 Date: Feb. 28, 2024

(30) Foreign Application Priority Data
Sep. 13, 2021 (NO) 20211081

(51) Int. Cl. B66D 1/74; B66D 1/12

(52) U.S. Cl. CPC B66D 1/7436; B66D 1/12; B66D 1/7478

(57) ABSTRACT

A power assist system for a manually operated winch includes a winch having a central winch shaft, an electric motor with a drive shaft and a motor control unit, a winch handle adjusted for manually operating the winch, and a control input device. The electric motor and the drive shaft are connected to the winch and the central winch shaft through a connection module placed below said winch. The winch handle is arranged to temporarily and mechanically connect with an upper end of the central winch shaft to allow manual operation of the winch. The control input device includes one or more electronic unit(s), built into, or mounted onto said winch handle. The control input device is further arranged to send wireless control signals through radio transmitter and receiver to the motor control unit. The wireless control signals are arranged to be temporarily but uniquely linked to the motor control unit to selectively control the winch that the winch handle is temporarily connected to. The control input device is adjusted to send different wireless control signals to the motor control unit depending on the direction the winch is manually operated in. The winch handle is adjusted to generate and/or store the energy needed to operate the control input device.

### FIELD OF THE INVENTION

The present invention relates to a power assist system for manually operated winches. More particularly, the present invention relates to an electric motor that may be mounted below a winch to assist the operation of the winch and a separate winch handle that via a wireless radio link is temporarily and uniquely linked to a control unit controlling the electric motor.

### BACKGROUND OF THE INVENTION

Winches are typically used for pulling in lines attached to sails on sailboats or lines and ropes on other boats. They are typically operated manually by a winch handle that through gears in the winch rotates the winch drum that pulls in the lines. Specially on larger boats the force needed to operate a winch can be substantial and more recently applications of electric motors have been utilized to drive winches.

Such systems typically have different problems or shortcomings. In the system described by Diebler in WO9403390A1 the electric motor is mounted in the winch handle itself. Even if this winch handle is a separate unit that may be moved from winch to winch (there are typically four or more winches on a sailboat) it is bulky, heavy, and difficult to move around. The speed and force available to rotate the winch is limited due to the relatively small motors that can be fitted to the handle itself. This system typically has batteries inside the handle to run the motor. Again, due to the limited space the batteries must be small, and this limits the operation time of the system before it must be recharged.

Another shortcoming of the system described by Diebler is that the torque produced by the motors must be countered by manual force applied to the handle by the operator, thus limiting the possible amount of motor assist.

Another power assisted winch is described by Geagan in U.S. Pat. No. 7,556,241. In the preferred embodiment of his invention the system is a dedicated winch system that must be built into the boat in which it is to be used. One feature, however, of the system described by Geagan is that the torque produced when force is applied to the winch handle is picked up by a torque sensor attached to a separate shaft that the winch handle is connected to. This torque sensor produces an electric signal that is sent through electrical signal wires to a control unit that controls the amount of power produced by a motor that, through gears, are connected to the winch. The output power from the motor is directly linked to the signal from the torque sensor to give the operator a “feel” for the force being applied to the line and also a “feel” for the conditions of the line, sail, anchor or other load being pulled in by the winch.

The lack of more sophisticated ways of linking the force applied to the winch handle to the power output from the motor (e.g. through so-called PID regulators) may create problems when the winch handle is rotated by the operator. Due to the way such winch handles are operated it is difficult to apply the same force throughout a rotation. The varying manual force is in Geagans invention duplicated by the motor and in fact increases the variations in pulling force applied to the line being pulled in by the winch.

In the industry there are also several examples of non-manual winches that are driven by motors being controlled by wireless remote controls. These systems obviously lack the “feel” described by Geagan. You typically need a separate controller for each winch or switches on the controller enabling a particular winch.

The present invention overcomes the problems and shortcomings described above by suggesting a power assist system that is operated with a winch handle equipped with sensors and wireless communication means. The control input device integrated in the winch handle also has features that temporarily links it to the motor controller in the winch that it is currently connected to. This feature enables a single winch handle to be used on several different winches employing the present invention without the danger of the winch handle unintentionally starting the motor in other systems. The winch handle of the present invention also has other features that increase the safety and the ease of use.

### SUMMARY OF THE INVENTION

A power assist system for a manually operated winch, comprising a winch having a central winch shaft, an electric motor with a drive shaft and a motor control unit, a winch handle adjusted for manually operating the winch and a control input device, characterized in that the electric motor and the drive shaft are connected to the winch and the central winch shaft through a connection module placed below said winch, and the winch handle is adjusted to temporarily and mechanically connect with an upper end of the central winch shaft to allow manual operation of the winch, and the control input device comprises one or more electronic unit(s) built into, or mounted onto said winch handle, and the control input device being further adjusted to send wireless control signals through radio transmitting and receiving means to the motor control unit, and the wireless control signals are adjusted to be temporarily but uniquely linked to the motor control unit to selectively control the winch that the winch handle is temporarily connected to, and the control input device is adjusted to send different wireless control signals to the motor control unit depending on the direction (CW/CCW) the winch is manually operated in, and the winch handle is adjusted to generate and/or store the energy needed to operate the control input device.

### BRIEF DESCRIPTION OF THE DRAWINGS

For the purpose of illustrating the present invention, a preferred embodiment is shown, however, this invention is not limited to the precise arrangements and design shown in the figures.

FIG. 1 shows a perspective view of the present invention.

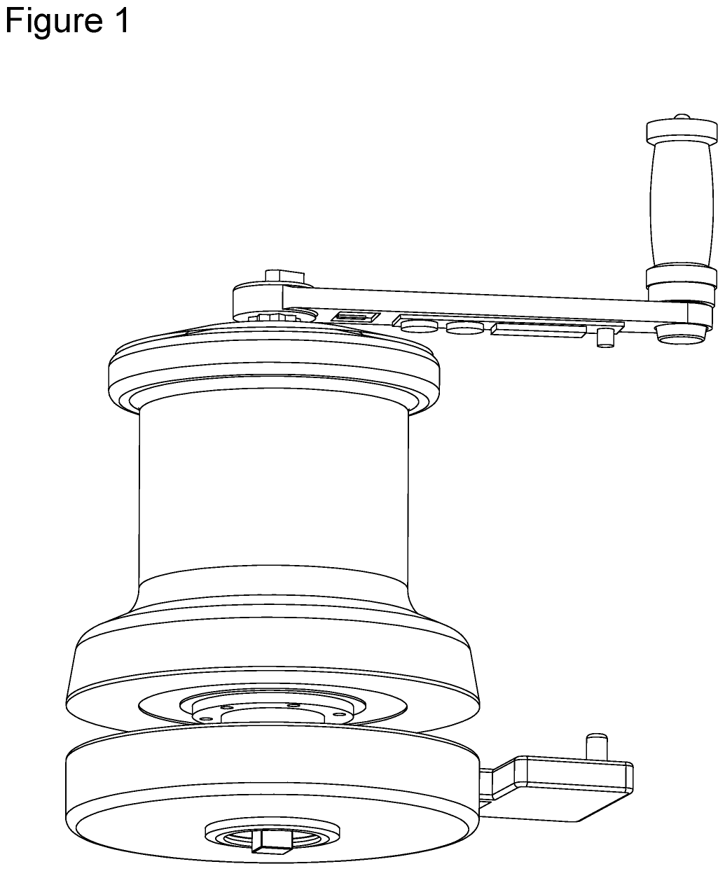

FIG. 2 shows a partly exploded perspective view seen from above showing the elements of the present invention.

FIG. 3 shows a partly exploded perspective view seen from below showing the elements of the present invention.

FIG. 4 shows a partly exploded side view of the present invention.

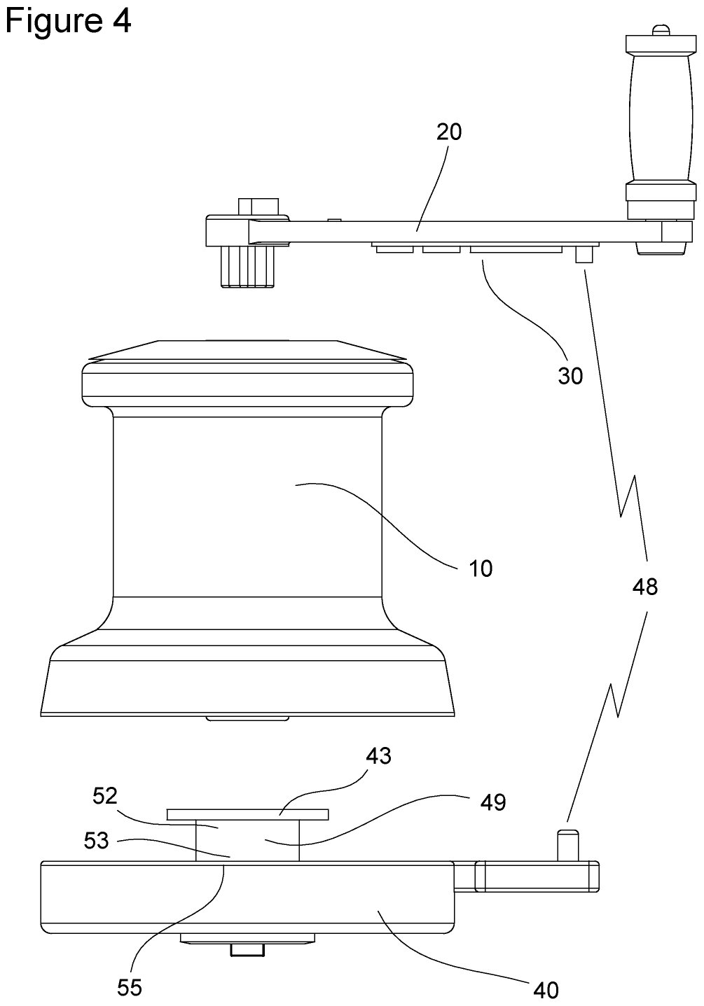

### DETAILED DESCRIPTION OF THE PREFERRED EMBODIMENT

Referring to the drawings, the layout and elements of a power assist system according to the present invention including an industry standard winch is shown. The winch described in the present invention may preferably be mounted on a sailboat to haul in sails and ropes, but the invention may have application in many other areas as well.

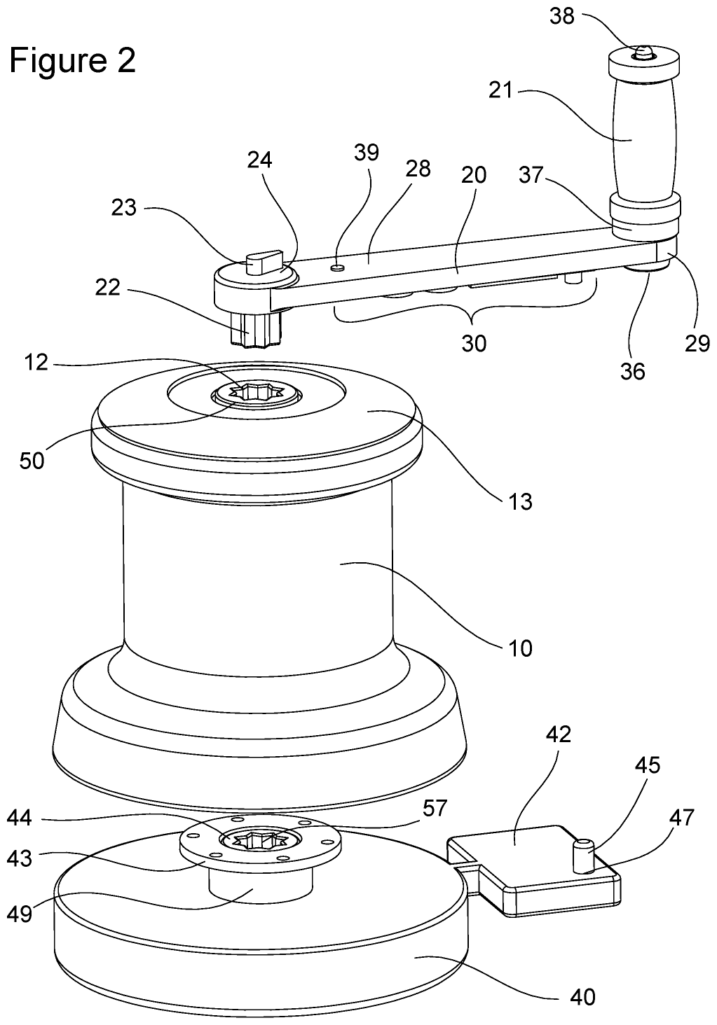

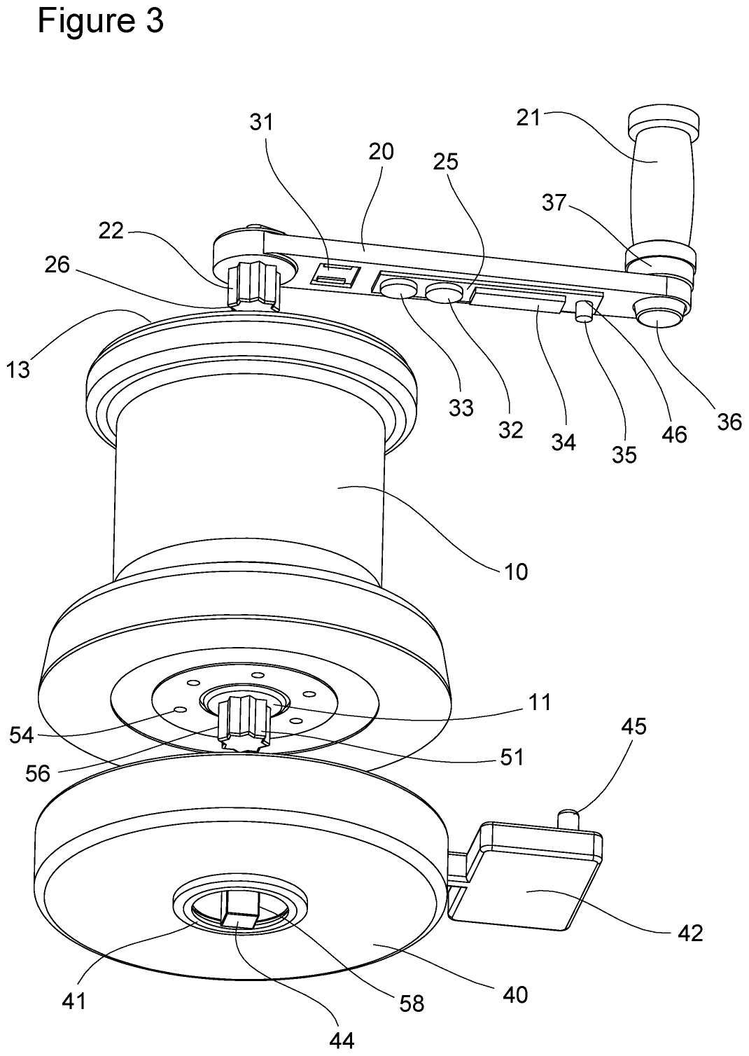

Referring to FIGS. 2 and 3, a preferred embodiment of the present invention is shown. The winch 10 can be a specially designed winch, but in this preferred embodiment the winch 10 is an industry standard winch that is prepared for being optionally driven by a motor 40 mounted below the winch 10. In its central upper part, the winch 10 has a winch socket 12 connected to a central winch shaft 11 protruding all the way through the winch 10 and being exposed at the bottom of the winch 10.

The deck of the boat that the winch 10 is mounted on should typically have an opening just below the winch 10 allowing the electric motor 40 to be mounted to the winch 10, centrally placed under the deck below the winch 10. A connection module 49 comprising a mounting bracket 43 and a connection shaft 44 is used to fix the electric motor 40 to the winch 10 and to connect the motor drive shaft 41 to the central winch shaft 11. To be able to transfer torque from the electric motor 40 to the central winch shaft 11 the lower part 51 of the central winch shaft 11 is typically equipped with ridges 56 or edges designed to rotationally lock into similar shaped features 57 on the connection shaft 44.

In an alternative embodiment of the present invention the connection module 49 may be a separate unit screwed onto both the winch 10 and the electric motor 40, but in the present preferred embodiment the connection module 49 is an integrated part of the electric motor 40. Furthermore, the drive shaft 41 is hollow allowing the connection shaft 44 to be vertically moved inside the drive shaft 41. The inner lower part of the drive shaft 41 is also equipped with ridges or edges (not shown) designed to rotationally lock into similar shaped features 58 on the outer lower part of the connection shaft 44. If the connection shaft 44 is pulled down so the ridges or edges on the connection shaft 44 no longer interlocks with the central winch shaft 11, the electric motor 40 is mechanically disconnected from the winch 10.

In other embodiments of the present invention the vertical movement of the connection shaft 44 could be accommodated by e.g. a servomotor or actuator making it possible to electronically disconnect the electric motor 40 in an emergency. In yet other embodiments the connection shaft 44 could be replaced by a clutch or other means using friction to rotationally connect the drive shaft 41 to the central winch shaft 11.

In this preferred embodiment of the present invention the electric motor 40 is a permanent magnet 3-phase motor of large diameter and low height. The large diameter gives the motor 40 high torque and low speed, making it ideal for directly connecting it to a winch 10 without the need for any gears. The low height makes it possible to install the system under the deck of e.g. a sailboat without substantially reducing the space available for the crew. Yet other embodiments of the present invention could use electric motors of different types or shapes, including motors with higher rotational speeds that need to be connected to the winch through reduction gears. Referring to FIGS. 2 and 3, the motor control unit 42 is shown as a unit placed outside the electric motor 40, however, in other embodiments of the present invention the motor control unit 42 is placed inside the motor to simplify the connection of motor wires and motor position sensors (not shown). The motor control unit 42 comprises a microprocessor and high-power transistors to control the current fed to the different phases in the electric motor 40. The algorithms used to control the electric motor 40 will be described in more details later.

The motor control unit 42 comprises radio transmitting and receiving means 47 that receives and transmits radio signals 48 through a motor radio antenna 45. The radio signals 48 come from similar radio transmitting and receiving means 46 in the winch handle 20.

The winch handle 20 shown in all the drawings has the same shape and features as industry standard winch handles. In its inner end the winch handle 20 of this preferred embodiment has a winch handle bit 22 protruding vertically down. Typically, the winch handle bit 22 has an 8-corner star shape or a 4-corner square shape. These shapes fit into the industry standard 8-cornered star shape of the winch socket 12. More or less all winches intended for use on a sailboat have a winch socket that follows this standard.

In this preferred embodiment of the present invention the winch handle bit 22 has a locking mechanism 26 to lock the winch handle 20 to the winch 10 during operation. This locking mechanism 26 is controlled by a spring-loaded release knob 23 placed on the inner upper part of the winch handle 20. A winch handle grip 21 is rotationally and vertically mounted at the outer end 29 of the winch handle 20. The winch handle grip 21 is protruding upwards and is used by the winch operator to turn the winch 10. During operation the operator typically holds the winch handle grip 21 firmly while he or she turns the winch 10. Since the winch handle grip 21 is rotationally mounted, the winch handle grip 21 will rotate with respect to the winch handle 20, one revolution for each full turn of the winch handle 20. In one embodiment of the present invention this rotation is through gears (not shown) used to drive a generator input shaft 38 of a small generator 36 placed at the outer end 29 of the winch handle 20. The power from the generator 36 could be used for driving an electronic control input device 30 in the winch handle 20 and/or to charge the rechargeable battery 34 in the winch handle 10.

In the preferred embodiment of the present invention the rechargeable battery 34 is charged through a wireless charger 32 integrated in the control input device 30. The rechargeable battery 34 is typically a lithium-polymer battery, but any kind of rechargeable battery could alternatively be used.

A sunlight visible LED light 39 is placed on the upper surface 28 of the winch handle 20 to give visual feedback to the winch operator. The LED light 39 is controlled by the control input device 30 and may use different colors and/or flashing patterns to report the status of the electronics (e.g., on, off, standby, radio link established, alarms).

To be able to use the winch handle 20 of the present invention on other winches equipped with the same power assist system is an important feature of the system. However, since the winch handle 20 communicates with the motor control unit 42 via a wireless radio link, it is important that the motor control unit 42 only reacts to commands being sent from the winch handle 10 currently being temporarily connected to the winch 10. There are several ways of securing that the winch handle 10 only sends valid commands to the motor control unit 42. One way is to use different frequencies on different winches and then have a frequency selector switch on the winch handle. One other way is to use “time of travel” techniques to only accept commands from a winch handle located very close to the winch. Yet another way is to place different unique patterns (magnetic or visual) into the winch socket and have a sensor in the winch handle bit that can read this pattern.

In the preferred embodiment of the present invention, however, the control input device 30 picks up a unique address of the winch 10 from an NFC (Near-Field Communication) tag 13 placed on the top of the winch 10 using an NFC device and an NFC antenna 33 on the winch handle 10. Before being mounted onto the top surface of the winch 10 the NFC tag 13 has been programmed with the unique address used by the motor control unit 42 to validating commands from the wireless link. To save power and secure the stability of the system the NFC tag 13 is only read if a command is given to the control input device 30 to do so. In this preferred embodiment, this command is initiated by flipping the release knob 23 rapidly two times. The movement of the release knob 23 is detected by a knob sensor 24 that triggers a knob input signal to the control input device 30.

By flipping the release knob 23 in different ways, additional commands could be sent to the control input device 30, e.g. switch on the electronics or turn off the radio link. When the winch handle 20 is actively controlling the electric motor 40, any movement of the release knob 23 is detected as a command to switch off the radio link and delete the unique winch address. This feature secures that all active control stops as soon as the winch handle 10 is released from the winch socket 12 and moved away.

During normal operation of the system, any force being applied to the winch handle grip 21 is picked up by one or more strain gauge(s) 31 connected to the control input device 30. The strain gauge 31 is typically firmly glued to a precisely prepared area close to the inner part of the winch handle 20 where the stress in the material of the winch handle 20 is at its highest. Even if any stiff material (e.g., plastics, composites and metals) may be used to manufacture the winch handle 10, tests has shown that aluminum is well suited for this purpose. It is relatively stiff, light weight and bends evenly under mechanical stress, thus giving precise readings from the strain gauge 31. Based on the strain gauge readings, a microprocessor 25 in the control input device 30 calculates the turning force applied to the winch 10 by the winch operator and adjusts the values based on calibration parameters stored by the microprocessor 25. These calibration parameters secure that different winch handles (of the present system) send the same commands to control the electric motor 40 for a given applied force from the operator.

The microprocessor 25 in the control input device 30 filters out the strain gauge readings to prevent errors and miss-readings to be sent to the motor control unit 42. The microprocessor 25 also corrects for any drift (e.g. temperature drift) in the strain gauge 31. When the control input device 30 is switched on, a calibration of the zero-level or neutral level from the strain gauge 31 is performed. This zero-level is later also used for determining the direction (CW or CCW) in which the manual force is applied to the winch handle grip 21.

In alternative embodiments of the present invention, different sensors may be used to determine the force applied to the winch handle grip 21. Those sensors may be pressure sensors, optical sensors or any kind of sensor prepared for reading forces or material stress and bending.

After the microprocessor 25 in the control input device 30 has calculated the direction and amount of force applied to the winch handle grip 21 it is sent as a “target value” to the motor control unit 42 via the handle radio antenna 35 on the winch handle side and the motor radio antenna 45 on the motor control side. The unique address for the winch 10, being described earlier, is embedded in the target values and commands being sent to secure that the correct electric motor 40 is controlled. The target value is calculated and sent to the motor control unit 42 several times each second. Typically, this could be 100 times pr. second.

When the commands sent by the wireless radio link 48 are received and validated by the microprocessor in the motor control unit 42 they are used to control the current fed to the different phases in the electric motor 40. Typically, this is done by sending rapid sequences of current pules into the phase cables, and by controlling the width of the pulses the average current is controlled.

The electric power typically comes from batteries onboard the boat, but these batteries are not shown, and they are not a direct part of the current invention.

Before the current pulses are sent to the motor phases, the target values and commands received from the winch handle 10 is processed through different time-delay functions to determine the amount of power to be supplied as well as the rotational direction of the electric motor 40. There is a relatively good correlation between the current sent to an electric motor and the torque produced by the motor, therefore the current running through the electric motor 40 is continuously measured by the motor control device 42. The microprocessor in the motor control device 42 then uses a first time-delay function to increase the output current if the measured current is below the target value, and it uses a second time-delay function to decrease the current if the measured current is above the target value.

The first and second time-delay functions should be tuned to the actual system, the possible torque produced by the motor, maximum rotational speed, available voltage and current, rotational moments of inertia for the motor and winch and the internal gearing of the winch. Typically, the time-delay functions are used to smooth out the torque and speed from the electric motor 40 to get a natural feel for the winch operator.

One implementation of the time-delay functions used in the preferred embodiment of the present invention is to use the output from the functions to control the width of the current pulses being sent to the different motor phases. Furthermore, if the measured current running thorough the electric motor 40 is below the received target value, the width of the output pulses are increased by a predefined value every time the microcontroller loops through the first time-delay function, and if the measured current running thorough the electric motor 40 is above the received target value, the width of the output pulses are reduced by a (different) predefined value every time the microcontroller loops through the second time-delay function. This way of controlling the electric motor 40 introduces an important feature of the present invention by de-coupling the target value for torque (and current running through the motor) from the width of the current pulses sent to the motor phases. This way the pulses could increase in width to effectively increase the speed of the electric motor 40 and thereby the winch 10 even if the target value for torque (and current) is relatively low.

The 3-phase electric motor 40 comprises several so-called hall effect sensors that measure the position and the rotational movement of the motor. These sensors are used to determine the optimal point in time when the motor control unit sends current pulses into the different electric phases to keep the motor running in an optimal way. These sensors are also used to measure the actual rotation of the winch. The rotational speed may also be measured by electromagnetic gyro sensors in the control input device 30. This actual rotational speed, or more precisely variations in rotational speed could together with variations in measured force be used in alternative embodiments of the present invention to modify the first and the second time-delay functions to keep the total winch power (manual and powered) relatively constant.

Lastly, the present invention has several protection and safety features. The hall effect sensors are used to detect if the rotational movements of the winch 10 stops while the operator is still trying to rotate the winch 10 with the winch handle 20. In this case the electric motor 40 is stalled, but a lot of current is running through the motor without managing to rotate it. This situation could potentially, within seconds, increase the heat generated in the electric motor 40 to a level where the motor will be damaged. Therefore, if the motor control unit 42 detects that the motor has stalled it will, depending on time and measured current start to reduce the electric current sent to the motor. If the situation remains, the current will eventually be reduced to zero. Furthermore, if the measured current gets above predetermined threshold values the width of the current pulses sent to the motor phases will be automatically reduced to keep the current within the maximum allowed values.

Another potentially dangerous situation in a power assist system like in the current invention is when the load of the winch suddenly goes from a high level to a very low level (e.g. if a line or rope breaks). In this case, and because of the different filters and time-delay functions, the winch 10 could rapidly and unintentionally speed up and start to pull the winch handle 20 out of the hands of the operator. To prevent this, the actual measured motor speed is used to trigger special routines in the microprocessor in the control input device 30 the effectively and very quickly reduce the width of the current pulses sent to the electric motor 40.

Furthermore, in an alternative embodiment, the control input device 30 is adjusted to send an active control signal or a control signal indicating operation of the winch 10 only when a separate presence sensor 37 in the winch handle 20 is activated by the winch operator.

Finally, the electric power to the system could be cut by an emergency safety switch that physically disconnects the electric wires to the system.

1. A power assist system for a manually operated winch, the power assist system comprising:
a winch having a central winch shaft, an electric motor with a drive shaft and a motor control unit, a winch handle adjusted for manually operating the winch, and a control input device, wherein
the electric motor and the drive shaft are connected to the winch and the central winch shaft through a connection module placed below said winch, and
the winch handle is arranged to temporarily and mechanically connect with an upper end of the central winch shaft to allow manual operation of the winch, and
the control input device comprises one or more electronic unit(s), built into, or mounted onto said winch handle, and
the control input device is further arranged to send wireless control signals through radio transmitting and receiving means to the motor control unit, and
the wireless control signals are arranged to be temporarily but uniquely linked to the motor control unit to selectively control the winch that the winch handle is temporarily connected to, and
the control input device is adjusted to send different wireless control signals to the motor control unit depending on the direction the winch is manually operated in, and
the winch handle is adjusted to generate and/or store the energy needed to operate the control input device.

2. The power assist system according to claim 1, where the connection module is a separate unit with an upper part and a lower part, said connection module comprises a mounting bracket and a connection shaft adjusted to fit existing mounting holes and drive shafts in industry standard winches in its upper part and to fit mounting means in the electric motor and drive shaft in its lower part.

3. The power assist system according to claim 1, where the connection module is an integrated upper part of the motor and further being adjusted to fit existing mounting holes and drive shafts (i.e. the central winch shaft) in industry standard winches.

4. The power assist system according to claim 1, where the winch handle comprises a winch handle bit adjusted to rotationally lock into a winch socket connected to an upper part of the central winch shaft, the winch handle bit further comprising a vertical locking means operated by a release knob, and where said release knob is adjusted to trigger a knob input signal to the control input device.

5. The power assist system according to claim 4, where the control input device is adjusted to use the knob input signal to activate or deactivate one or more of the said electronic modules and/or the wireless control signals.

6. The power assist system according to claim 4, where the control input device is adjusted to use the knob input signal to activate an NFC antenna sending radio signals and receiving information from an NFC tag mounted on the winch, and where said information includes a unique address for the winch, enabling the motor control unit to only react to control signals being sent from the winch handle currently connected to said winch.

7. The power assist system according to claim 1, where the control input device comprises an NFC antenna adjusted to send radio signals and receiving information from an NFC tag mounted on the winch, and where said information includes a unique address to the winch, enabling the motor control unit to only react to control signals being sent from the winch handle currently connected to said winch.

8. The power assist system according to claim 1, where the motor control unit is adjusted to measure the current running through the electric motor and furthermore use a first time-delay function to increase this current if the measured current is below a target value, and to use a second time-delay function to decrease the current if the measured current is above the target value, and where the target value and the rotational direction is controlled by the wireless signals received from the control input device in the winch handle.

9. The power assist system according to claim 8, where the first and the second time-delay functions use the rotation speed of the winch handle and registered variations in the force applied to the winch handle during a rotation to adjust the time delay functions to keep the total winch power (manual and powered) relatively constant.

10. The power assist system according to claim 8, where the control input device is further adjusted to send target values depending on the amount of manual force applied to the winch handle and where the amount of manual force is determined by an electronic module comprising a strain gauge mounted on the winch handle.

11. The power assist system according to claim 8, where the control input device is adjusted to send an active control signal or a control signal indicating operation of the winch only when a separate presence sensor in the winch handle is activated by a winch operator.

12. The power assist system according to claim 1, where the control input device comprises a rechargeable battery.

13. The power assist system according to claim 12, where the control input device comprises a wireless charging means adjusted to charge the rechargeable battery.

14. The power assist system according to claim 12, where the winch handle comprises a generator adjusted to generate power that is used to charge the rechargeable battery, and where said generator comprises a generator input shaft that is rotationally connected to a winch handle grip vertically mounted on an outer end of the winch handle.

15. The power assist system according to claim 1, where the control input device comprises a LED light visible on an upper surface of the winch handle and where the control input device is adjusted to give status information through said LED light.

16. A method for providing power assist to a winch comprising:
Providing an electric motor having a drive shaft connected to the winch and a motor control unit for controlling the turning force and direction of the electric motor, thus turning the winch via the drive shaft, and
Providing a winch handle comprising a control input device including a force sensor arranged to measure the force applied to the handle by a user, and further comprising wireless communication means for transmitting a wireless control signal representing the turning direction and force measured by the sensor to wireless communication means in the motor control unit, and
Configuring the motor control unit to cause the electric motor to apply a turning force to the winch based upon the wireless control signal transmitted by the control input device, and
Configuring the control input device to send different wireless control signals to the motor control unit depending on the duration and amount of force being picked up by said force sensor when the winch is manually operated, and force is applied to the winch handle.

17. The method for providing power assist to a winch according to claim 16, where the winch handle comprises a winch handle bit adjusted to rotationally lock into said winch socket, the winch handle bit further comprising a vertical locking means operated by a release knob, and where said release knob is adjusted to trigger a knob input signal to the control input device.

18. The method for providing power assist to a winch according to claim 17, where the control input device is configured to use the knob input signal to activate or deactivate said microprocessor and/or the wireless control signals.

19. The method for providing power assist to a winch according to claim 17, where the control input device is configured to use the knob input signal to activate an NFC antenna sending radio signals and receiving information from an NFC tag mounted on the winch, and where said information includes a unique address for the winch, enabling the motor control unit to only react to control signals being sent from the winch handle currently connected to said winch.

20. The method for providing power assist to a winch according to claim 16, where the motor control unit is configured to measure the current running through the electric motor and furthermore use a first time-delay function to increase this current if the measured current is below a target value, and to use a second time-delay function to decrease the current if the measured current is above the target value, and where the target value and the rotational direction is controlled by the wireless signals received from the control input device in the winch handle.

21. The method for providing power assist to a winch according to claim 20, where the first and the second time-delay functions use the rotation speed of the winch handle and registered variations in the force applied to the winch handle during a rotation to adjust the time delay functions to keep the total winch power (manual and powered) relatively constant.

22. The method for providing power assist to a winch according to claim 20, where the control input device is further configured to send target values depending on the amount of manual force applied to the winch handle and where the amount of manual force is determined by said force sensor mounted on the winch handle.

23. A power assist system for a manually operated winch, the power assist system comprising:
an electric motor with a drive shaft and a motor control unit, a winch handle configured for manually operating a winch with a central winch shaft protruding down below said winch and a control input device, wherein
the electric motor and the drive shaft are connected to the winch and the central winch shaft through a connection module placed below said winch, and
the winch handle is configured to temporarily and mechanically connect with an upper end of the central winch shaft to allow manual operation of the winch (10), and
the control input device comprises a microprocessor and a force sensor and is built into, or mounted onto said winch handle, and
the control input device is further configured to send wireless control signals through radio transmitting and receiving means to the motor control unit, and
the wireless control signals are configured to be temporarily and uniquely linked to radio transmitting and receiving means in the motor control unit to selectively control the winch that the winch handle is temporarily connected to, and
the control input device is configured to send different wireless control signals to the motor control unit depending on the direction the winch handle is manually operated in, and
the winch handle is configured to store the energy needed to operate the control input device.

24. A power assist device for a manually operated winch, comprising an electric motor arranged to be connected to a winch, and a winch handle adapted to be temporarily engaged with the winch, the handle having an internal power supply and a transmitter/receiver device in wireless communication with a motor control unit, the winch handle further having sensors to sense the amount of force and direction of rotation applied to the winch handle by a user, and a microprocessor arranged to send wireless signals to the motor control unit controlling the electric motor to apply an amount torque to the winch, in a particular direction, based on the wireless signals from the winch handle.
